(19) United States
(12) Patent Application Publication
(10) Pub. No.: US 2009/0191016 A1
(43) Pub. Date: Jul. 30, 2009

(54) Drill

(75) Inventor: Norihiro Masuda, Aichi (JP)

Correspondence Address: Muramatsu & Associates, 114 Pacifica, Suite 310, Irvine, CA, 92618, US

(73) Assignee: OSG CORPORATION, AICHI (JP)

(21) Appl. No.: 11/886,707

(22) PCT Filed: Apr. 4, 2005
(86) PCT No.: PCT/JP2005/006603

§ 371 Date: Dec. 31, 2007

(51) Int. Cl. B23B 51/02

(52) U.S. Cl. 408/230

(57) ABSTRACT

A drill is designed to ensure wear resistance to achieve extended tool life. In the drill, at least the surface of the cutting edge is coated with a hard compound, and the film thickness dimension of the hard compound is set to be within the range of 0.1 μm or more and 1.0 μm or less. Further, the thickness dimension of the web thickness formed by the web of the groove portion is set to be within the range of 0.15 D or more and 0.25 D or less relative to the outer diameter D of the cutting edge. Consequently, chip dischargeability can be synergistically improved. As a result, there is an effect in that it is possible to prevent chip welding to thereby synergistically improve the life of the drill.

### TECHNICAL FIELD

The present invention relates to drills, and more specifically to a drill that can ensure wear resistance and achieve extended tool life.

### BACKGROUND ART

A drill is a drilling tool for cutting a workpiece by a cutting edge formed at the tip. The surface of a drill is generally coated with a hard compound such as TiN, TiAIN, or TiCN. Such a coating hardens the surface of the drill for improved wear resistance, thereby achieving extended tool life.

However, when the surface of a drill is coated, its cutting edge becomes rounded, resulting in a decrease in the sharpness of the drill. Such a decrease in sharpness leads to a decrease in chip braking performance, causing chip packing, which brings about troubles such as a deterioration in machined hole accuracy and drill breakage.

In view of this, Japanese Patent Application Laid-Open Publication No. 2003-251503 describes a technique in which the film thickness dimension of a coating is set to be within the range of 0.05 μm or more and 3.0 μm or less. According to this technique, since the film thickness dimension is set to 0.05 μm or more, it is possible to ensure the wear resistance of the drill. Further, since the film thickness is set to 3.0 μm or less, it is possible to prevent the cutting edge from being rounded, thereby suppressing chip packing.
Patent Document 1: Japanese Patent Application Laid-Open Publication No. 2003-251503 (paragraph [0028], FIG. 1, etc.)

### DISCLOSURE OF THE INVENTION

### Problem to Be Solved by the Invention

However, the above-described drill does not provide a sufficient measure for facilitating the discharge of chips. Further, since a thick coating film is deposited on the tip of the edge, the edge tip R becomes larger, and its sharpness decreases. Chips are thus deposited on the tip of the drill, which induces welding at the tip of the drill. As a result, troubles as drill breakage are caused, resulting in a decrease in tool life.

The present invention has been made with a view to solving the problems described above, and it is accordingly an object of the present invention to provide a drill that can ensure wear resistance to achieve extended tool life.

### Means for Solving the Problem

For achieving the object, claim 1 defines a drill comprising: a drill body that is rotated about a center axis; a groove portion formed in a spiral or substantially linear fashion in an outer peripheral surface portion from a tip of the drill body to a shank; a leading edge formed in a ridge portion between a wall surface facing a direction of rotation of the groove portion and the outer peripheral surface portion; and a cutting edge formed at the tip of the drill body, the drill being formed of a cemented carbide including tungsten carbide, wherein: at least the cutting edge has its surface coated with a hard compound; a film thickness dimension of the hard compound is set to be within a range of 0.1 μm or more and 1.0 μm or less; and a thickness dimension of a web thickness formed by a web of the groove portion is set to be within a range of 0.15 D or more and 0.25 D or less relative to the outer diameter D of the cutting edge.

According to claim 2, in the drill defined by claim 1, an average grain size of the tungsten carbide is set to 0.5 μm or less.

### Effect of the Invention

According to the drill as defined in claim 1, at least the surface of the cutting edge is coated with a hard compound, and the film thickness dimension of the hard compound is set to be within the range of 0.1 μm or more and 1.0 μm or less. If the film thickness dimension of the hard compound is less than 0.1 μm, the surface of the cutting edge cannot be sufficiently hardened, which makes it impossible to ensure wear resistance.

On the other hand, if the film thickness dimension of the hard compound is more than 1.0 μm, the cutting edge becomes rounded, resulting in a decrease in sharpness. As a result, the chip breaking performance decreases, causing a deterioration in machined hole accuracy and drill breakage due to chip packing. For these reasons, by setting the film thickness dimension of the hard compound to be within the range of 0.1 μm or more and 1.0 μm or less, there is an effect in that it is possible to ensure wear resistance, and prevent a deterioration in machined hole accuracy and drill breakage.

Further, the thickness dimension of the web thickness formed by the web of the groove portion is set to be within the range of 0.15 D or more and 0.25 D or less relative to the outer diameter D of the cutting edge. If the thickness dimension of the web thickness is smaller than 0.15 D, the strength of the drill decreases, making the drill prone to breakage. On the other hand, if the thickness dimension of the web thickness is larger than 0.25 D, the groove portion becomes shallow, resulting in a decrease in chip dischargeability. As a result, chip welding is induced, causing a deterioration in machined hole accuracy and drill breakage. For these reasons, by setting the thickness dimension of the web thickness to be within the range of 0.15 D or more and 0.25 D or less, there is an effect in that it is possible to endure the strength of the drill, and prevent a deterioration in machined hole accuracy and drill breakage.

Further, by setting the film thickness dimension of the hard compound and the web thickness to be within the above-mentioned ranges and using them in combination, chip dischargeability can be synergistically improved. As a result, there is an effect in that it is possible to prevent chip welding to thereby synergistically improve the life of the drill.

According to the drill as defined in claim 2, in addition to the effect provided by the drill as defined in claim 1, the average grain size of tungsten carbide forming the drill is set to be 0.5 μm or less. Therefore, there is an effect in that it is possible to ensure the hardness of the drill to thereby achieve extended life of the drill.

Further, there is an effect in that if the hardness is the same, a drill whose average grain size is set to 0.5 μm or less makes it possible to ensure toughness and prevent chipping as compared with a drill whose average grain size is set to be larger than 0.5 μm.

### BRIEF DESCRIPTION OF THE DRAWINGS

FIG. 1 is a front view of a drill according to an embodiment of the present invention.

FIG. 2 is a view of the tip face of the drill.

### EXPLANATION OF REFERENCE NUMERALS AND SYMBOLS

1 Drill
2 Shank
3 Drill body
4 Groove portion
5 Cutting edge
6 Leading edge
X Thickness dimension

### BEST MODE FOR CARRYING OUT THE INVENTION

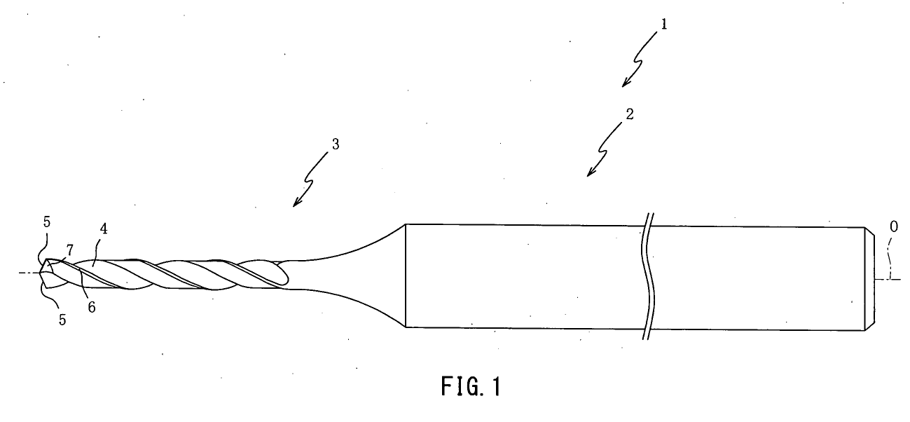

Hereinbelow, preferred embodiments of the present invention will be described with reference to the attached drawings. FIG. 1 is a front view of a drill 1 according to an embodiment of the present invention. It should be noted that illustration of the axial length of a shank 2 is omitted in FIG. 1.

The drill 1 is a cutting tool of a small diameter for drilling a hole in a stainless work material such as a shaft part, a nozzle part, or a medical part by means of torque transmitted from machining equipment (drill press or the like). As shown in FIG. 1, the drill 1 mainly includes a shank 2 held by the above-mentioned machining equipment, and a drill body 3 that performs cutting of a workpiece.

It should be noted that the surface of the drill 1 is coated with TiAIN that is a hard compound, and the film thickness dimension of TiAIN is set to be within the range of 0.1 μm or more and 1.0 μm or less. If the film thickness dimension of TiAIN is less than 0.1 μm. the surface of the drill 1 cannot be sufficiently hardened, which makes it impossible to ensure wear resistance.

On the other hand, if the film thickness dimension of TiAIN is more than 1.0 μm, a cutting edge 5 becomes rounded, resulting in a decrease in sharpness. As a result, the chip breaking performance decreases, causing a deterioration in machined hole accuracy and breakage of the drill 1 due to chip packing. For these reasons, by setting the film thickness dimension of TiAIN to be within the range of 0.1 μm or more and 1.0 μm or less, it is possible to ensure wear resistance, and prevent a deterioration in machined hole accuracy and breakage of the drill 1.

While in this embodiment TiAIN is used as the hard compound, this should not be construed restrictively. A hard compound such as TiN, TiC, or TiCn may be used as well. Further, although the entire surface of the drill 1 is coated with the hard compound, this should not be construed restrictively. It suffices that at least the surface of the cutting edge 5 is coated.

In the drill 1 according to this embodiment, the outer Diameter D of the cutting edge 5 is set to 3.0 mm or less to perform small-diameter drilling. Therefore, when the drill 1 is coated with a hard compound, the rounding of the cutting edge 5 due to coating becomes pronounced, resulting in a significant decrease in sharpness. For this reason, when using the drill 1 according to this embodiment, setting the film thickness dimension of the hard compound to 1.0 μm or less as described above proves very effective in preventing a deterioration in machined hole accuracy and breakage of the drill 1.

The shank 2 and the drill body 3 are integrally formed, and made of a cemented carbide obtained by adding cobalt as a binder to fine powder of tungsten carbide (hereinafter, referred to as WC) and pressure-sintering the resultant powder.

The average grain size of WC is set to 0.5 μm or less. This makes it possible to ensure the hardness of the drill 1, thereby extending the life of the drill 1.

Since the outer diameter D of the cutting edge 5 is set to 3.0 mm or less as described above in the drill 1 according to this embodiment, the strength of the drill 1 cannot be ensured. For this reason, when using the drill 1 according to this embodiment, setting the average grain size of WC to 0.5 μm or less to ensure the hardness and toughness of the drill 1 proves very effective in extending the life of the drill 1.

Provided that the hardness is the same, the drill 1 whose average grain size is set to 0.5 μm or less makes it possible to ensure toughness and prevent chipping as compared with a drill whose average grain size is set to be larger than 0.5 μm.

The shank 2 is the portion held by the machining equipment. In this embodiment, the outer diameter dimension of the shank 2 is set to be larger than the outer diameter D of the cutting edge 5, and the shank 2 is formed so as to extend straight substantially in parallel to the center axis O.

The drill body 3 mainly includes a groove portion 4 formed in a spiral fashion in the outer peripheral surface portion thereof, the cutting edge 5 formed at the tip of the drill body 3, and a leading edge 6 formed in the ridge portion between the wall surface facing toward the direction of rotation of the groove portion 4 and the outer peripheral portion.

The connecting portion between the drill body 3 and the shank 2 is tapered so as to increase in diameter toward the shake 2 side (right side in FIG. 1).

The groove portion 4 is a groove provided in the form of a recess in the outer peripheral surface portion of the drill body 3 in order to discharge chips, with the leading edge 6 arranged in the ridge portion between the wall surface facing toward the direction of rotation and the outer peripheral surface portion.

While the groove portion 4 according to this embodiment is formed in a spiral fashion from the distal end side (left side in FIG. 1) toward the shank 2, this should not be construed restrictively. The groove portion 4 may be formed linearly so as to be substantially parallel to the center axis O.

It is desirable that the helix angle, which is an angle formed between the leading edge 6 and a straight line parallel to the center axis O, be set to be within the range of 15 degrees or more and 35 degrees or less. This makes it possible to ensure both the rigidity of the drill body 3 and chip dischargeability.

The cutting edge 5 is used for drilling a hole in a workpiece by means of torque from machining equipment, and arranged at the tip of the drill body 3.

While the point angle of the cutting edge 5 is set to 120 degrees in this embodiment, this should not be construed restrictively. The point angle may be set to be within the range of 110 degrees or more and 140 degrees or less. This makes it possible to ensure the strength and biting of the cutting edge 5, thereby ensuring hole accuracy and extending the life of the drill 1.

A relief surface 7 is a surface that is relieved to reduce friction at the time of cutting, and is connected to the rear in the rotational direction of the cutting edge 5.

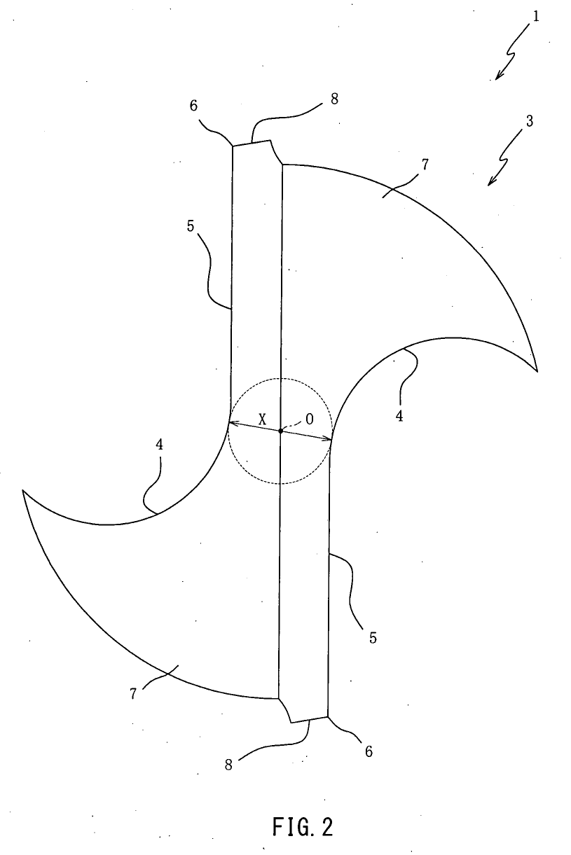

Next, the tip of the drill body 3 will be described with reference to FIG. 2. FIG. 2 is a view of the tip face of the drill 1.

A margin 8 is for polishing the inner wall surface of a machined hole, and connected to the rear in the rotational direction of the cutting edge 5 (clockwise in FIG. 2). While one margin 8 is provided in this embodiment, this should not be construed restrictively. A second margin may be arranged in the rear in the rotational direction of the margin 8.

As shown in FIG. 2, the thickness dimension X of the web thickness formed by the web of the groove portion 4 is set to be within the range of 0.15 D or more and 0.25 D or less relative to the outer diameter D of the cutting edge 5. If the thickness dimension X of the web thickness is smaller than 0.15 D, the strength of the drill 1 decreases, making the drill 1 prone to breakage.

On the other hand, if the thickness dimension X of the web thickness is larger than 0.25 D, the groove portion 4 becomes shallow, resulting in a decrease in chip dischargeability. As a result, welding due to accumulation of chips is induced, causing a deterioration in machined hole accuracy and breakage of the drill 1. For these reasons, by setting the thickness dimension X of the web thickness to be within the range of 0.15 D or more and 0.25 D or less, it is possible to endure the strength of the drill 1, and prevent a deterioration in machined hole accuracy and breakage of the drill 1.

Now, description will be given of the results of an endurance test conducted by using the drill 1 constructed as described above. The illustration of the results of the endurance test is omitted.

The endurance test is a test conducted to examine how the film thickness dimension of the hard compound, the thickness dimension X of the web thickness, and the average grain size of WC affect the tool life, in which the film thickness dimension, the thickness dimension, and the average grain size are each fixed to a predetermined value for comparison against that of a drill according to the related art. Further, in this test, drilling to a hole depth of 7.2 mm is continuously performed, and a tool-life comparison is made on the basis of the length of cut calculated as the product of the number of drilled holes and the hole depth of 7.2 mm.

The detailed specifications of the endurance test are as follows: Work Material: SUS420J2, Cutting Speed: 40 m/min, Feed Rate: 0.04 mm/rev, Hole Depth: 7.2 mm, Outer Diameter of Cutting Edge: 1.82 mm, and Coating Material: TiAIN.

In the drill 1 according to this embodiment, the film thickness dimension, the thickness dimension X, and the average grain size are respectively fixed at 0.8 μm, 0.18 D, and 0.3 μm. In the drill 1 according to the related art, the film thickness dimension, the thickness dimension X, and the average grain size are respectively fixed at 2.5 μm, 0.3 D, and 1.25 μm.

When the drill 1 according to this embodiment was used, the number of drilled holes was 53,000 (length of cut: 380 m), after which point it became impossible to continue machining due to breakage of the drill 1.

On the other hand, when the drill according to the related art was used, the number of drilled holes was 20,000 (length of cut: 140 m), after which point it became impossible to continue machining due to breakage of the drill 1.

From the above results of the endurance test, it is assumed that by setting the film thickness dimension of the hard compound to be within the range of 0.1 μm or more and 1.0 μm or less, it was possible to ensure wear resistance and prevent a decrease in sharpness to thereby achieve extended life of the drill 1.

Further, it is assumed that by setting the thickness dimension X of the web thickness to be within the range of 0.15 D or more and 0.25 D or less, it was possible to ensure the strength of the drill 1 and prevent a decrease in chip dischargeability to thereby achieve extended life of the drill 1.

Furthermore, it is assumed that by setting the average grain size of WC to be 0.5 μm or less, it was possible to ensure the hardness of the drill 1 to thereby achieve extended life of the drill 1.

Further, chip dischargeability can be synergistically improved by setting each of the film thickness dimension of the hard compound, the thickness dimension X of the web thickness, and the average grain size of WC to be within the above-mentioned range. As a result, it is possible to prevent welding of chips to thereby synergistically improve the life of the drill 1.

Although the present invention has been described above by way of its embodiments, the present invention is by no means limited to the respective embodiments mentioned above, and it can be easily inferred that various improvements and modifications are possible without departing from the scope of the present invention.

For example, while the drill 1 according to this embodiment is formed as a small-diameter drill whose drill body 3 has a very fine tip, the drill may be formed as a drill whose drill body 3 has a tip of substantially the same diameter as the shank 2.

1. A drill comprising:
a drill body that is rotated about a center axis; a groove portion formed in a spiral or substantially linear fashion in an outer peripheral surface portion from a tip of the drill body to a shank;
a leading edge formed in a ridge portion between a wall surface facing a direction of rotation of the groove portion and the outer peripheral surface portion; and
a cutting edge formed at the tip of the drill body, the drill being formed of a cemented carbide including tungsten carbide,
wherein: an outer diameter D of the cutting edge is set to 3.0 mm or less;
a point angle of the cutting edge is set to be within a range of 110 degrees or more and 140 degrees or less;
at least the cutting edge has its surface coated with a hard compound;
a film thickness dimension of the hard compound is set to be within a range of 0.1 μm or more and 1.0 μm or less;
a thickness dimension of a web thickness formed by a web of the groove portion is set to be within a range of 0.15 D or more and 0.25 D or less relative to the outer diameter D of the cutting edge; and
an average grain size of the tungsten carbide is set to 0.5 μm or less.

2. (canceled)
